(19) United States
(12) Patent Application Publication
(10) Pub. No.: US 2019/0283288 A1
(43) Pub. Date: Sep. 19, 2019

(54) FOAMED HEAT-INSULATING MATERIAL PRODUCTION METHOD, AND FOAMED HEAT-INSULATING MATERIAL

(71) Applicant: Mitsubishi Electric Corporation, Chiyoda-ku, Tokyo (JP)

(72) Inventors: Yusuke NAKANISHI, Tokyo (JP); Yuta KUBO, Tokyo (JP); Masaru IMAIZUMI, Tokyo (JP); Kazushi KONO, Tokyo (JP)

(73) Assignee: Mitsubishi Electric Corporation, Chiyoda-ku, Tokyo (JP)

(21) Appl. No.: 16/461,225

(22) PCT Filed: Nov. 22, 2017
(86) PCT No.: PCT/JP2017/041954

§ 371 Date: May 15, 2019

(30) Foreign Application Priority Data
Dec. 7, 2016 (JP) 2016-237257

(51) Int. Cl. B29C 44/44; C08J 9/228

(52) U.S. Cl. CPC B29C 44/445; B29K 2105/251; C08J 9/228

(57) ABSTRACT

Provided is a foamed heat-insulating material which encapsulates therein a low-heat conductivity gas and which yields high heat insulating performance. High-melting point beads that have been foamed up to a prescribed expansion ratio with a gas of low thermal conductivity by using a resin that does not soften at the beads-foaming temperature and that has a low gas transmission rate are mixed with low-temperature foam beads to be foamed within a forming die, and the resultant mixture is filled in a beads forming die cavity and foamed by heating.

### TECHNICAL FIELD

The present invention relates to a foamed heat-insulating material production method and a foamed heat-insulating material.

### BACKGROUND ART

A foamed heat-insulating material is a cell structure encapsulating a gas in spaces defined by walls of a resin and having a diameter of less than approximately 1 mm. In order to secure a thermal conductivity of, for example, less than 0.04 W/mK, which is close to an upper limit of thermal conductivity of foamed plastic heat-insulating materials that is provided in Japanese Industrial Standards “Thermal Insulating Materials and Products for Buildings”, the foamed heat-insulating material needs to encapsulate a large amount of the gas therein and have a relative density of less than 1/10 with respect to the resin of the same volume. In order to implement higher heat insulating performance, methods such as micronizing cells while maintaining a high expansion ratio, using a resin of a low thermal conductivity or a gas of a low thermal conductivity, and minimizing radiant heat are adopted.

As a foamed heat-insulating material of high heat insulating performance, rigid urethane foam using hydrocarbon as a foaming agent is known. The rigid urethane foam encapsulates in foam cells hydrocarbon such as pentane and butane, which has a lower thermal conductivity than air, and carbon dioxide generated by urethane reaction so as to obtain a thermal conductivity of approximately 0.02 W/mK lower than the air. However, the rigid urethane foam has disadvantages including lower heat resistance and lower flame resistance, molding time as long as several minutes, and need of explosion-protected construction of a production plant and equipment, which increases cost for capital investment.

In view of this, the rigid urethane foam is replaced with a mold beads foaming method of forming a foamed heat-insulating material into a shape of a product to be installed by a single molding step. This mold beads foaming method includes a preliminary foaming step of dissolving an evaporation foaming agent such as hydrocarbon in bead-shaped resin particles, and heating the resin to vaporize the foaming agent and expand the beads. After the preliminary foaming step, the preliminarily foamed beads are filled in a forming die. Then, the beads are heated by heated vapor or the like and re-foamed to fuse surfaces of the particles to one another. A formed product thus obtained is kept still in a drying chamber for approximately a whole day and night to dry and stabilize shrinkage after forming.

Exemplary resins used for the above-described mold beads foaming method include polystyrene, polypropylene, and polyethylene. Exemplary hydrocarbons include butane, propane, and pentane. The hydrocarbon gas in the foam cells is replaced with air while kept still after forming.

As a method for improving heat insulating performance of a foamed heat-insulating material obtained by the mold beads foaming method, a production method including adding a substance to decrease a radiant component is known as disclosed in, for example, JP-A-2003-192821 (Patent Literature 1).

### CITATION LIST

### Patent Literature

[Patent Literature 1] JP-A-2003-192821

Foamed heat-insulating materials obtained by mold beads foaming methods including the above-described example of the related art have air filled in foam cells irrespective of kinds of resins, kinds of foaming agents, and production methods. This makes it impossible to make a thermal conductivity lower than the thermal conductivity of air, which is 0.024 W/mK.

Since the production method for improving the heat insulating performance disclosed in patent document 1 produces an effect limited to decreasing radiant heat, an improvement effect that compensates for an increase in material cost by adding the additive cannot be unfortunately obtained.

### SUMMARY OF THE INVENTION

### Technical Problem

The invention has been made to solve the above problems, and an object of the invention is to provide a foamed heat-insulating material production method and a foamed heat-insulating material that yield high heat insulating performance.

### Solution to Problem

A foamed heat-insulating material production method according to the invention is characterized by comprising: a step of preliminarily foaming high-melting point beads that keep internal gas lower in thermal conductivity than air at a mold beads forming temperature; a step of mixing the foamed high-melting point beads with low-temperature foam beads and filling a mixture in a forming die; and a step of heating the high-melting point beads and the low-temperature foam beads that have been filled in the forming die at the mold beads forming temperature. The low-temperature foam beads after mold beads forming have a smaller size than the high-melting point beads.

### Advantageous Effects of Invention

The foamed heat-insulating material production method according to the invention causes the high-melting point beads to be preliminarily foamed by a forming method different from beads foaming. Consequently, the gas having a lower thermal conductivity than air can be filled in cells, and the cells can be micronized so as to secure high heat insulating performance and reduce energy consumption of a product to be installed.

### BRIEF DESCRIPTION OF THE DRAWINGS

FIG. 1 is a perspective view of a foamed heat-insulating material according to a first embodiment of the invention.

FIG. 2 is a cross-sectional view of the foamed heat-insulating material according to the first embodiment of the invention.

FIG. 3a is a schematic diagram illustrating a state of a material from a material filling step to a mold beads-foaming forming step of the foamed heat-insulating material according to the first embodiment of the invention.

FIG. 3b is a schematic diagram illustrating a state of the material from the material filling step to the mold beads-foaming forming step of the foamed heat-insulating material according to the first embodiment of the invention.

FIG. 4 is a schematic diagram illustrating a production method of high-melting point beads by extrusion molding according to the first embodiment of the invention.

FIG. 5a is a schematic diagram illustrating a production method of the high-melting point beads using an autoclave according to the first embodiment of the invention.

FIG. 5b is a schematic diagram illustrating the production method of the high-melting point beads using the autoclave according to the first embodiment of the invention.

FIG. 6 is a cross-sectional view of a foamed heat-insulating material according to a second embodiment of the invention.

FIG. 7 is a schematic structural diagram illustrating a foamed bead according to a third embodiment of the invention.

FIG. 8 is a schematic structural diagram illustrating a high-melting point bead according to a fourth embodiment of the invention.

FIG. 9 is a cross-sectional view of a foamed heat-insulating material according to a seventh embodiment of the invention.

FIG. 10 is a cross-sectional view of a foamed heat-insulating material according to an eighth embodiment of the invention.

FIG. 11 is a cross-sectional view of a foamed heat-insulating material according to a ninth embodiment of the invention.

FIG. 12 is a cross-sectional view of a foamed heat-insulating material according to a tenth embodiment of the invention.

### DESCRIPTION OF EMBODIMENTS

The preferred embodiments of a foamed heat-insulating material production method and a foamed heat-insulating material according to the invention will be described below with reference to the drawings. In the drawings, the same or corresponding components are denoted with identical reference numerals and signs and will not be described repeatedly.

### First Embodiment

FIG. 1 is a perspective view of a foamed heat-insulating material according to a first embodiment of the invention. As illustrated in FIG. 1, a foamed heat-insulating material 1 is a three-dimensional structure including a main portion 1a, flanges 1b, a protrusion 1c, and a hole 1d in accordance with a shape of a product of the heat-insulating material to be installed, and these portions are integrally shaped by mold beads-foaming forming.

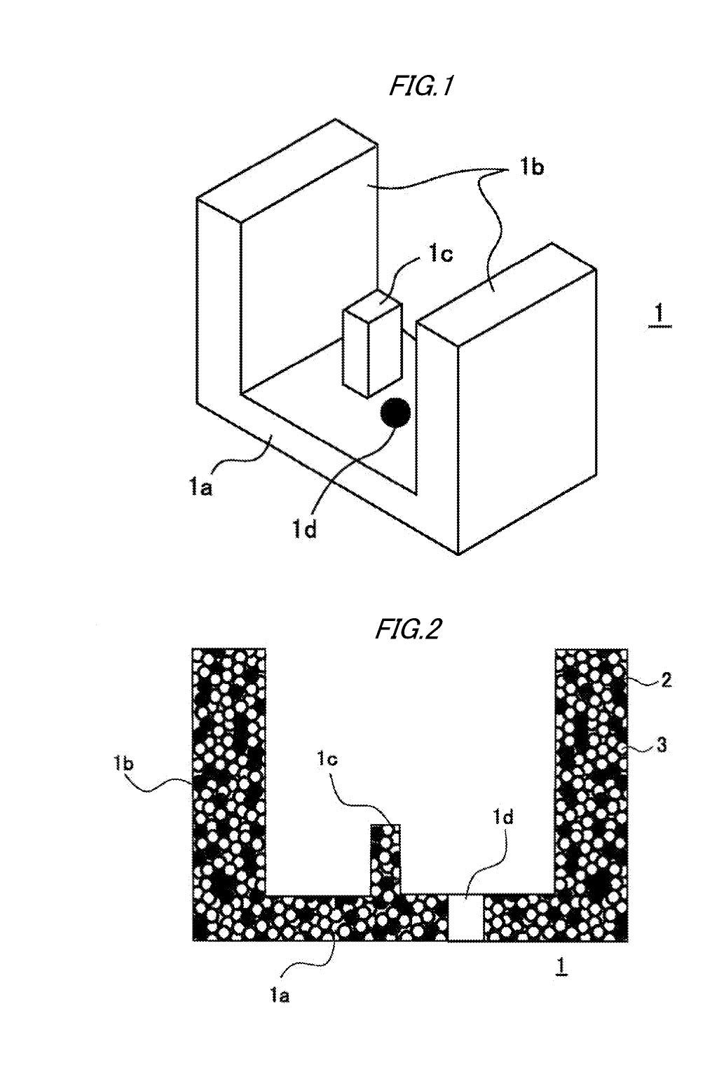

FIG. 2 is a cross-sectional view of a configuration of the foamed heat-insulating material 1. As illustrated in FIG. 2, the foamed heat-insulating material 1 is a molded product in which high-melting point beads 2 indicated by filled circles and low-temperature foam beads 3 indicated by open circles are mixed. The high-melting point beads 2 are made of a resin that does not soften even at a heated vapor temperature of 80 to 120° C. in mold beads forming. The high-melting point beads 2, which have been foamed into a final shape at a preliminary step, are filled in a beads forming die. As the resin material, examples include polyethylene terephthalate, polypropylene, thermoplastic polyurethane elastomer, and ethylene-vinyl alcohol copolymer resin. The low-temperature foam beads 3 are beads made of beads forming polystyrene for normal use, and soften and are foamed at the heated vapor temperature in mold beads forming.

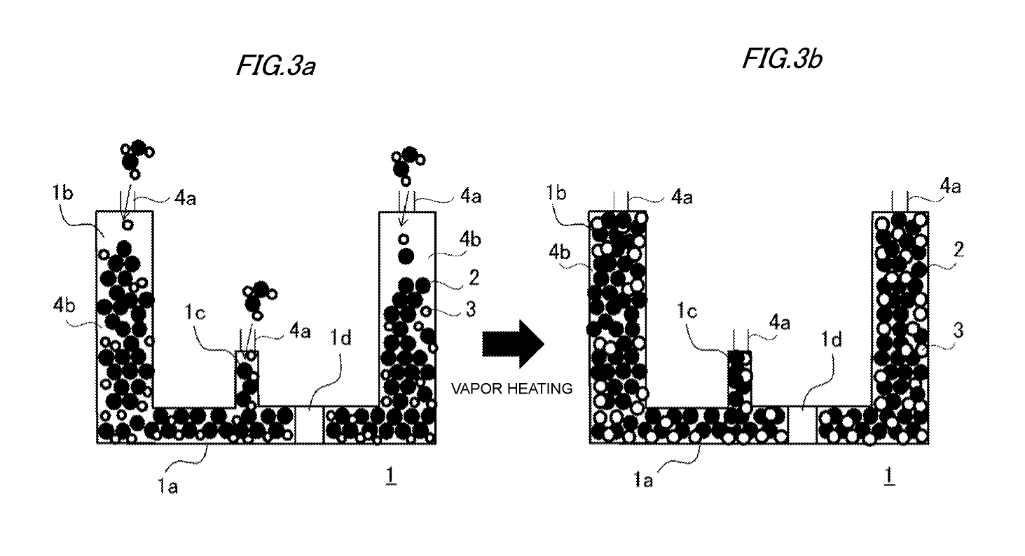

FIGS. 3a and 3b are schematic diagrams illustrating states of the material from a material filling step to a mold beads-foaming forming step of the foamed heat-insulating material 1.

As illustrated in FIG. 3a, the high-melting point beads 2 indicated by filled circles and the low-temperature foam beads 3 indicated by open circles, which have been mixed at a predetermined ratio in advance, are filled in a beads forming die cavity 4b from material supply ports 4a. After the material is filled, the die is filled with heated vapor supplied from heated vapor supply ports (not illustrated), and as illustrated in FIG. 3b, the high-melting point beads 2 and the low-temperature foam beads 3 are heated to a high temperature. Thus, the low-temperature foam beads 3 soften and are re-foamed by vaporization of the immersed foaming agent.

When the low-temperature foam beads 3 are re-foamed and expanded, the material is filled in the beads forming die cavity 4b with no gaps. Moreover, surfaces of the low-temperature foam beads 3 soften to fuse the low-temperature foam beads 3 to one another so as to maintain the shape even after removed from the die. While the low-temperature foam beads 3 are changing as described above, the high-melting point beads 2 do not soften and are not re-foamed, and keep internal gas lower in thermal conductivity than air and are maintained in a state prior to being filled in the beads forming die cavity 4b.

Next, production methods of the high-melting point beads 2 will be described. However, production methods of the high-melting point beads 2 according to the invention are not limited to these.

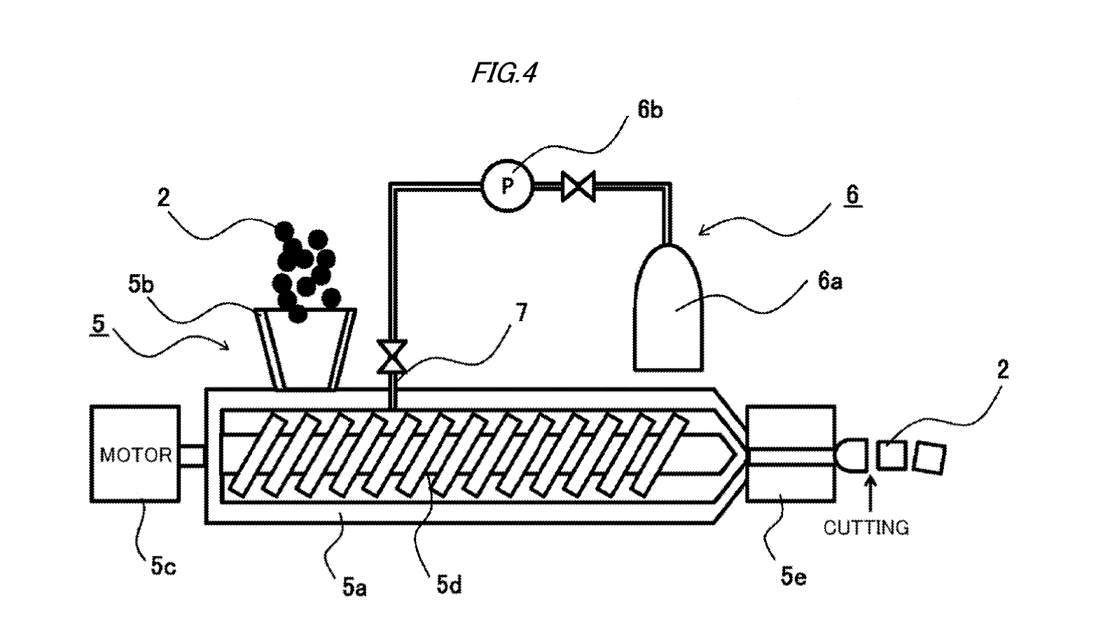

FIG. 4 is a schematic diagram illustrating a production method of the high-melting point beads 2 by foam extrusion molding. Referring to FIG. 4, a foam extrusion molding apparatus includes an extrusion molder 5 and a foaming agent supply device 6. The extrusion molder 5 and the foaming agent supply device 6 are coupled by a coupling valve 7 in an intermediate portion of a screw cylinder 5a of the extrusion molder 5. A resin material of the high-melting point beads 2 supplied from a material supply unit 5b is transferred to a die 5e by rotary motion of a screw 5d caused by drive of a motor 5c. In the transfer passage, the resin material is melted by heating by a heater (not illustrated) disposed at the screw cylinder 5a and by shear heating caused by rotation of the screw 5d.

A foaming agent from a foaming agent supply source 6a is increased to a predetermined pressure by a foaming agent supply pump 6b and mixed with the molten resin in the screw cylinder 5a. The foaming agent is dissolved in the resin by mixing by the screw 5d and a pressure of the resin in the screw cylinder 5a, and the mixture is extruded from the die 5e. Reduced in pressure when extruded from the die 5e, the dissolved foaming agent is vaporized, and the molten resin is cooled and solidified to form a foam molded product of the resin. After formed, the foam molded product is passed through a device, such as a pulverizer and a pelletizer, to cut the resin to a predetermined length, thereby forming the high-melting point beads 2.

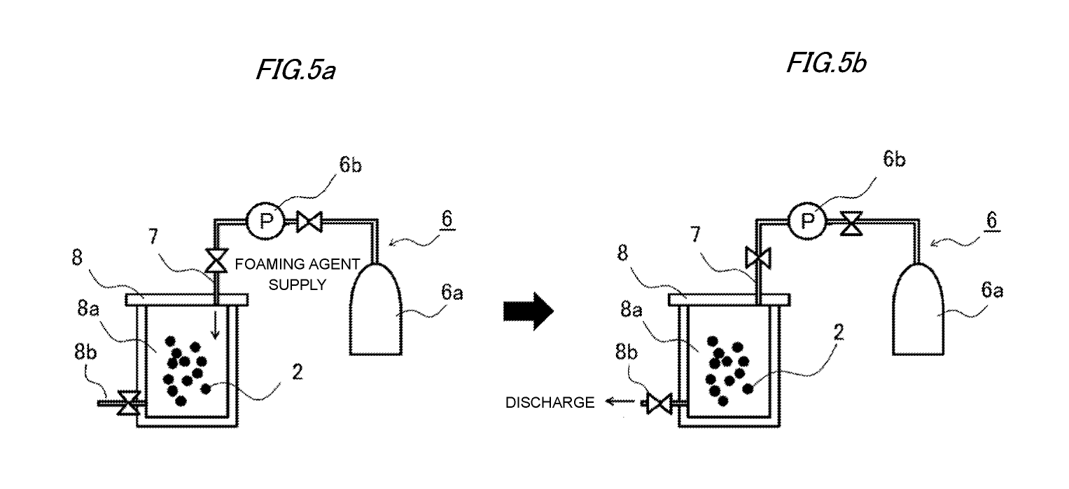

FIGS. 5a and 5b are schematic diagrams illustrating a production method of the high-melting point beads 2 by autoclave foaming. An autoclave 8 includes a material placement portion 8a and a discharge valve 8b and can heat the interior of the material placement portion 8a. As illustrated in FIG. 5a, through the foaming agent supply device 6 and the coupling valve 7, a foaming agent from the foaming agent supply source 6a is supplied to the material placement portion 8a. A resin material of the high-melting point beads 2 introduced to the material placement portion 8a is kept still for a predetermined period of time in a foaming gas atmosphere filled under high pressure to dissolve the foaming agent in the resin material.

As illustrated in FIG. 5b, after the foaming agent is dissolved, the resin material is heated into a rubber state. When the foaming agent is discharged from the discharge valve 8b, a pressure in the material placement portion 8a is decreased to cause the foaming agent dissolved in the resin material to vaporize to expand the resin material to obtain the high-melting point beads 2.

Alternatively, similarly to foamed beads of the related art, after immersing bead-shaped resin particles in a foaming agent, and when the resin is heated to vaporize the foaming agent, the preliminary foaming step may not be performed but the resin particles may be expanded to a predetermined foam expansion ratio to form the high-melting point beads 2.

When substances such as polyethylene terephthalate, nylon, and ethylene-vinyl alcohol copolymer resin are used as a resin material of the high-melting point beads 2, internal gas is less likely to transmit than three substances used for mold beads foaming of the related art, namely, polystyrene, polypropylene, and polyethylene. When hydrocarbons such as carbonic acid gas, butane, and pentane, and hydro-fluoro-olefin that have lower thermal conductivity than air are used as a foaming agent, the high-melting point beads 2 can maintain a lower thermal conductivity than the foamed beads of the related art.

According to the first embodiment, the gas having a lower thermal conductivity than air can be filled in foam cells of the high-melting point beads 2 in advance at a step prior to mold beads foaming, and the gas is less likely to transmit from the inside of the form cells so as to maintain a low thermal conductivity.

### Second Embodiment

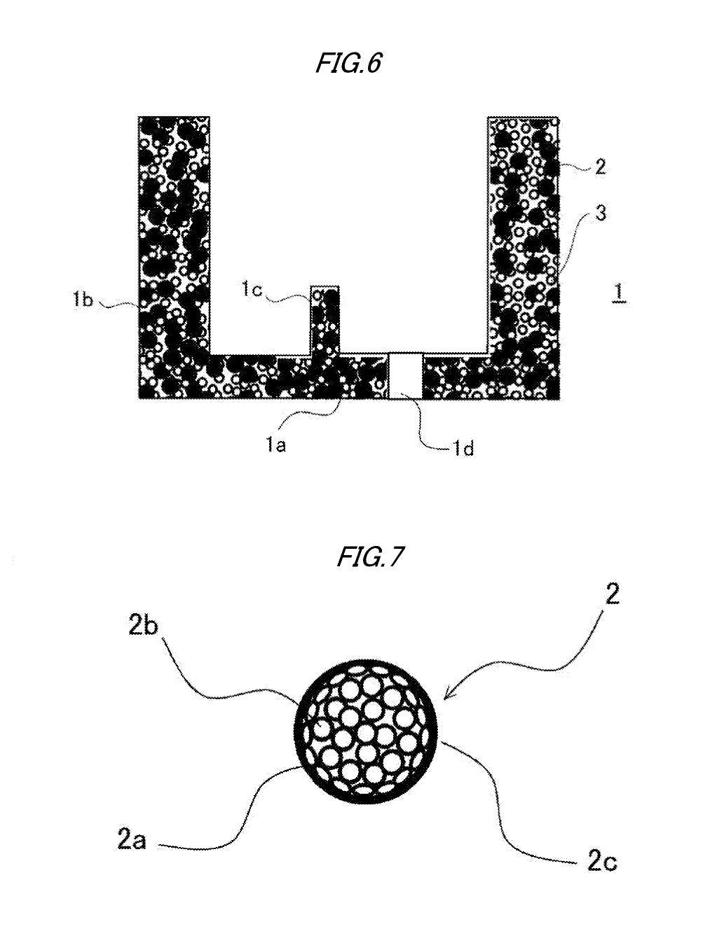

Next, a second embodiment of the invention will be described. FIG. 6 is a cross-sectional view of a foamed heat-insulating material according to the second embodiment.

As illustrated in FIG. 6, in the foamed heat-insulating material 1 according to the second embodiment, the high-melting point beads 2 indicated by filled circles are formed to be larger than the low-temperature foam beads 3 indicated by open circles. By making the high-melting point beads 2 larger than the low-temperature foam beads 3, a ratio of the high-melting point beads 2 in a volume of the foamed heat-insulating material 1 is increased even when the number of the high-melting point beads 2 is the same as the number of the low-temperature foam beads 3. Moreover, because the low-temperature foam beads 3 smaller than the high-melting point beads 2 are easier to enter gaps among the high-melting point beads 2, the low-temperature foam beads 3 are more likely to fuse to one another in mold beads-foaming forming.

According to the second embodiment, the ratio of the high-melting point beads 2 having high heat insulating performance in the volume can be increased to obtain still higher heat insulating performance. Because the low-temperature foam beads 3 are more likely to fuse to one another, a shape of the foamed heat-insulating material 1 can be more easily maintained.

### Third Embodiment

Next, a third embodiment of the invention will be described. FIG. 7 is a schematic structural diagram illustrating a high-melting point bead according to the third embodiment.

As illustrated in FIG. 7, the high-melting point bead 2 according to the third embodiment when foamed includes foam cells 2b covered with cell walls 2a, and a coating layer 2c is formed on an outer surface of the bead. The coating layer 2c has a gas barrier property and fusibility at the time of mold beads forming. Exemplary materials include polyvinyl alcohol and ethylene-vinyl alcohol copolymer resin.

Methods of forming the coating layer 2c include spray coating and immersion in a coating liquid tank, but are not limited to these. Alternatively, the foamed heat-insulating material 1 may include no low-temperature foam beads 3 but may have the coating layers 2c fused to one another by vapor heating at the time of mold beads forming to maintain the shape.

According to the third embodiment, the gas barrier property of the high-melting point beads 2 can be improved to maintain high heat insulating performance on a long-term basis. Moreover, the coating layers 2c are softened by vapor heating at the time of mold beads forming to make the high-melting point beads 2 have fusibility to eliminate need of the low-temperature foam beads 3. Even higher heat insulating performance can be obtained, and time for mold beads forming can be shortened to reduce production cost of the foamed heat-insulating material.

### Fourth Embodiment

Next, a fourth embodiment of the invention will be described. FIG. 8 is a schematic structural diagram illustrating a high-melting point bead according to the fourth embodiment.

As illustrated in FIG. 8, the high-melting point bead 2 according to the fourth embodiment includes an inner layer 2d and an outer layer 2e that differ in material, foam expansion ratio, and cell diameter. A resin of the outer layer 2e has a higher gas barrier property than a resin of the inner layer 2d.

The high-melting point bead 2 illustrated in the fourth embodiment is produced by extrusion molding, that is, multilayer forming of supplying two or more kinds of resins into a single die or by forming the inner layer 2d at a first extrusion molding step and adhering the outer layer 2e to an outer periphery of the inner layer 2d in a forming die while supplying the inner layer 2d from an upstream side of the die at a second extrusion molding step.

The high-melting point bead 2 may be obtained by supplying a foaming agent to an extruder of each of the inner layer 2d and the outer layer 2e and performing foam extrusion molding similarly to the first embodiment or by extrusion molding followed by autoclave foaming. Alternatively, similarly to foamed beads of the related art, after immersing a bead-shaped resin particle in a foaming agent for each of the inner layer 2d and the outer layer 2e, and when the resin is heated to vaporize the foaming agent, the preliminary foaming step may not be performed but the resin particle may be expanded to a predetermined foam expansion ratio to form the high-melting point bead 2. The number of layers is not be limited to 2.

According to the fourth embodiment, because the inner layer 2d is covered with the outer layer 2e, materials that have a low melting temperature and a low gas barrier property and are inexpensive and easy to foam and form, such as polyethylene and polystyrene, may be used for the inner layer 2d to reduce production cost and material cost.

### Fifth Embodiment

At the time of forming high-melting point beads, for example, a crystalline nucleating agent and a polymer chain extender may be added to materials.

When the high-melting point beads 2 are formed by foam extrusion molding described in the first embodiment, the crystalline nucleating agent and the polymer chain extender may be kneaded and dispersed in the high-melting point beads 2 in advance or the crystalline nucleating agent, the polymer chain extender and the like may be introduced from the material supply unit 5b (see FIG. 4) in a manner separate from a resin material, and kneaded and dispersed while passed through the screw cylinder 5a (see FIG. 4) by the mixing function of the screw 5d (see FIG. 4). One kind or a plurality of kinds of additives may be added.

According to the fifth embodiment, when a foaming agent is vaporized and expanded, addition of the crystalline nucleating agent increases the number of foam nuclei generated to micronize foam cells, and addition of the polymer chain extender improves viscosity of resin when foamed to stabilize bubbles in a micronized state, thus further improving heat insulating performance of the high-melting point beads 2.

### Sixth Embodiment

A radiation reducing agent may be added to high-melting point beads. Examples of the radiation reducing agent include carbon black, graphite, and titanium oxide. The radiation reducing agent may be added not only to the high-melting point beads but also to low-temperature foam beads or to both of the high-melting point beads and the low-temperature foam beads. When the high-melting point beads 2 are formed by foam extrusion molding described in the first embodiment, the radiation reducing agent maybe kneaded and dispersed in the high-melting point beads 2 in advance or maybe introduced from the material supply unit 5b (see FIG. 4) in a manner separate from a resin material, and kneaded and dispersed while passed through the screw cylinder 5a (see FIG. 4) by the mixing function of the screw 5d (see FIG. 4). One kind or a plurality of kinds of additives may be added.

According to the sixth embodiment, radiant heat can be reduced to obtain even higher heat insulating performance.

### Seventh Embodiment

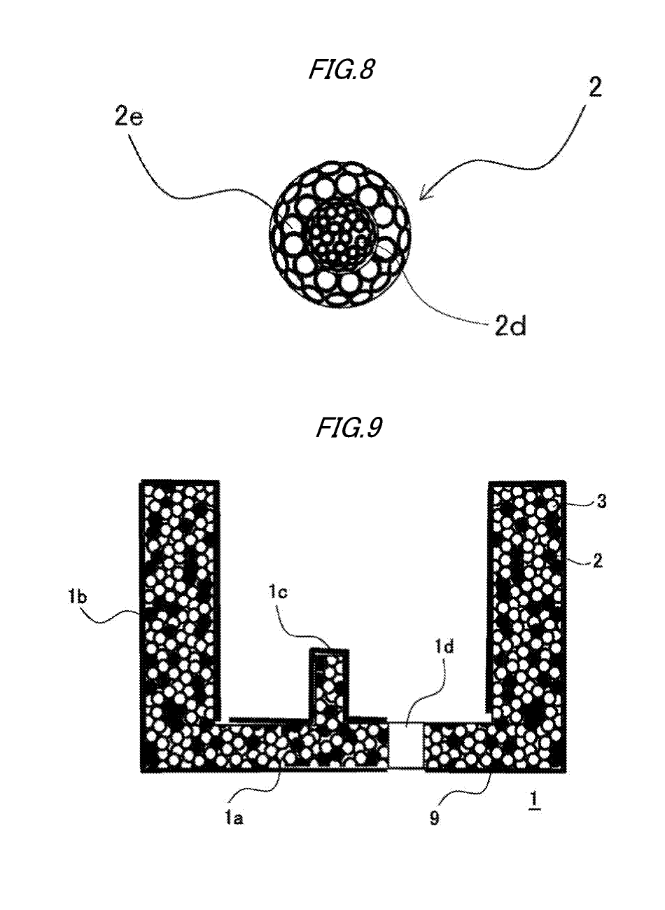

Next, a seventh embodiment of the invention will be described. FIG. 9 is a cross-sectional view of a foamed heat-insulating material according to the seventh embodiment.

As illustrated in FIG. 9, the foamed heat-insulating material 1 according to the seventh embodiment includes a film 9 on an outer periphery of the foamed heat-insulating material 1. The film 9 may be inserted into a die at the time of mold beads forming or adhered after mold beads forming. At a proximal portion of a protruding shape of, for example, the flanges 1b and the protrusion 1c, where an aspect ratio is high, the film 9 may be cut in advance to secure adhesiveness to the foamed heat-insulating material 1. The film 9 has a sufficient gas barrier property over use time of the foamed heat-insulating material 1 with respect to a gas encapsulated in the high-melting point beads 2 indicated by filled circles in the drawing. The film 9 has sufficient heat resistance and sufficient weather resistance in an environment where the foamed heat-insulating material 1 is installed. Examples of material includes polyethylene terephthalate, polychlorinated vinylene, aluminum vapor deposition layer, and stacked layer of these. The film 9 may be disposed in a die for heating and foaming the low-temperature foam beads 3 indicated by open circles in the drawing in advance or may be disposed by a vacuum packaging device or the like after heating and foaming, and drying and curing.

According to the seventh embodiment, even when the gas barrier property of the high-melting point beads 2 alone is insufficient for use time of the foamed heat-insulating material 1, the gas barrier property can be secured, and even when the high-melting point beads 2 and the low-temperature foam beads 3 do not fuse to each other by heating and foaming, the film 9 maintains the outer peripheral shape to secure the shape as a component. Thus, the high-melting point beads 2, the low-temperature foam beads 3, and the film 9 that are worth the production cost and the material cost can be selected to produce the foamed heat-insulating material 1 at more appropriate cost.

### Eighth Embodiment

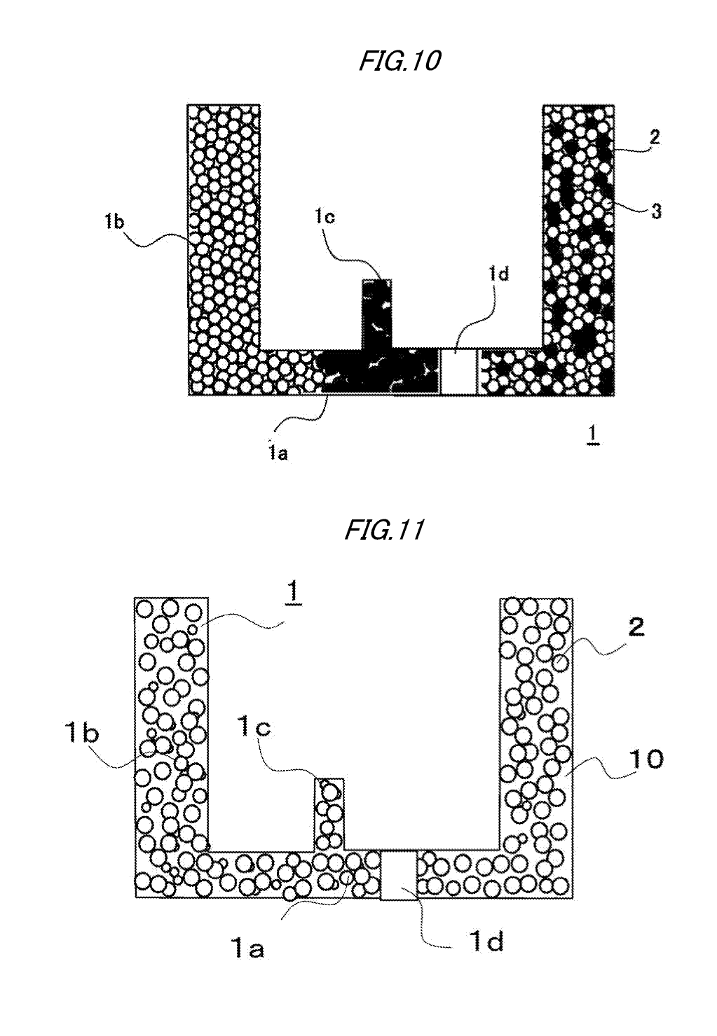

Next, an eighth embodiment of the invention will be described. FIG. 10 is a cross-sectional view of a foamed heat-insulating material according to the eighth embodiment.

As illustrated in FIG. 10, in the foamed heat-insulating material 1 according to the eighth embodiment, ratios of the high-melting point beads 2 indicated by filled circles and the low-temperature foam beads 3 indicated by open circles are different in accordance with portions of the foamed heat-insulating material 1. The protrusion 1c includes only the high-melting point beads 2, and the left flange 1b in the drawing includes only the low-temperature foam beads 3. For example, based on a specification required for a product in which the foamed heat-insulating material 1 is installed, when only the flange 1b needs high heat insulating performance, a ratio of the high-melting point beads 2 to the low-temperature foam beads 3 is increased in the flange 1b, and the beads are mixed and supplied into a forming die. A ratio of the high-melting point beads 2 to the low-temperature foam beads 3 is decreased in portions other than the flange 1b, and the beads are mixed and supplied into the forming die. Thus, heat insulating performance in each portion of the foamed heat-insulating material 1 is adjusted as necessary.

According to the eighth embodiment, even when the high-melting point beads 2 need higher production cost and higher material cost than the low-temperature foam beads 3, use amounts of the beads can be appropriately adjusted in accordance with the specification required for the product so as to reduce the production cost and the material cost.

### Ninth Embodiment

Next, a ninth embodiment of the invention will be described. FIG. 11 is a cross-sectional view of a foamed heat-insulating material according to the ninth embodiment.

As illustrated in FIG. 11, in the foamed heat-insulating material 1, a low-temperature foam filler 10 is filled in gaps among the filled high-melting point beads 2 indicated by open circles. The high-melting point beads 2 are made of a material that makes interior gas have a lower thermal conductivity than air even at a temperature at the time of reaction of the low-temperature foam filler 10. The low-temperature foam filler 10 is, for example, urethane foam. The reaction temperature and a foaming pressure of the low-temperature foam filler 10 are approximately 100° C. and approximately 0.1 MPa, which are substantially equal to a reaction temperature and a foaming pressure of heated vapor for beads forming. Therefore, the low-temperature foam filler 10 can be filled in the gaps without softening and deforming the high-melting point beads 2.

According to the ninth embodiment, even without beads forming equipment, the foamed heat-insulating material 1 having a low thermal conductivity can be produced by equipment for producing the low-temperature foam filler 10, and it is unnecessary to use hydrocarbon such as cyclopentane for the low-temperature foam filler 10, thus reducing equipment investment cost.

### Tenth Embodiment

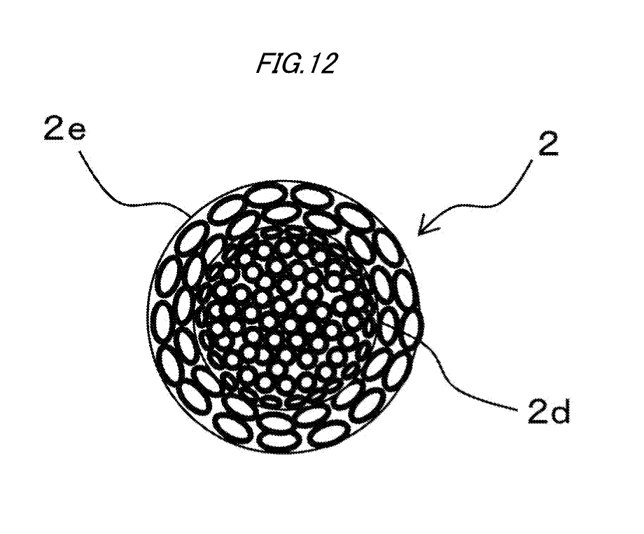

Next, a tenth embodiment of the invention will be described. FIG. 12 is a schematic structural diagram illustrating a high-melting point bead according to the tenth embodiment.

As illustrated in FIG. 12, the high-melting point bead 2 includes the inner layer 2d and the outer layer 2e that differ in material, foam expansion ratio, and cell diameter. A resin of the outer layer 2e softens at a vapor heating temperature in beads forming, and has a ratio of less than 30% to a volume of the high-melting point beads 2.

The high-melting point bead 2 illustrated in the tenth embodiment is produced by extrusion molding, that is, by multilayer forming of supplying two or more kinds of resins into a single die or by forming the inner layer 2d at a first extrusion molding step and adhering the outer layer 2e to an outer periphery of the inner layer 2d in the forming die while supplying the inner layer 2d from an upstream side of the die at a second extrusion molding step.

The high-melting point bead 2 may be obtained by supplying a foaming agent to an extruder of each of the inner layer 2d and the outer layer 2e and performing foam extrusion molding similarly to the first embodiment or by extrusion molding followed by autoclave foaming. Alternatively, similarly to foamed beads of the related art, after immersing a bead-shaped resin particle in a foaming agent for each of the inner layer 2d and the outer layer 2e, and when the resin is heated to vaporize the foaming agent, the preliminary foaming step may not be performed but the resin particle may be expanded to a predetermined foam expansion ratio to form the high-melting point bead 2. The number of layers is not be limited to 2.

According to the tenth embodiment, because the outer layers 2e are fused to one another at the time of beads forming to eliminate need of the low-temperature foam beads 3. Even when the outer layers 2e soften to allow gas of a low thermal conductivity to transmit, the whole heat-insulating material can be prevented from increasing the thermal conductivity so as to reduce production cost and material cost.

Although the first to tenth embodiments of the invention have been described heretofore, the embodiments of the invention can be freely combined and suitably modified and omitted within the scope of the invention.

### REFERENCE SIGNS LIST

1 . . . foamed heat-insulating material, 1a . . . main portion, 1b . . . flange, 1c . . . protrusion, 1d . . . hole, 2 . . . high-melting point bead, 2a . . . cell wall, 2b . . . foam cell, 2c . . . coating layer, 2d . . . inner layer, 2e . . . outer layer, 3 . . . low-temperature foam bead, 4a . . . material supply port, 4b . . . beads forming die cavity, 5 . . . extrusion molder, 5a . . . screw cylinder, 5b . . . material supply unit, 5c . . . motor, 5d . . . screw, 5e . . . die, 6 . . . foaming agent supply device, 6a . . . foaming agent supply source, 6b . . . foaming agent supply pump, 7 . . . coupling valve, 8 . . . autoclave, 8a . . . material placement portion, 8b . . . discharge valve, 9 . . . film, 10 . . . low-temperature foam filler

1.-24. (canceled)

25. A production method of a foamed heat-insulating material, the method comprising:
a step of preliminarily foaming high-melting point beads that keep internal gas lower in thermal conductivity than air at a mold beads forming temperature;
a step of mixing the foamed high-melting point beads with low-temperature foam beads and filling a mixture in a forming die; and
a step of heating the high-melting point beads and the low-temperature foam beads that have been filled in the forming die at the mold beads forming temperature,
wherein
the low-temperature foam beads after mold beads forming have a smaller size than the high-melting point beads.

26. The production method of the foamed heat-insulating material according to claim 25, wherein a coating layer is formed on an outer surface of each of the high-melting point beads.

27. The production method of the foamed heat-insulating material according to claim 25, wherein the high-melting point beads are produced by extrusion foam molding.

28. The production method of the foamed heat-insulating material according to claim 26, wherein the high-melting point beads are produced by extrusion foam molding.

29. The production method of the foamed heat-insulating material according to claim 25, wherein a ratio of the high-melting point beads and the low-temperature foam beads is changed in accordance with portions of the foamed heat-insulating material.

30. The production method of the foamed heat-insulating material according to claim 26, wherein a ratio of the high-melting point beads and the low-temperature foam beads is changed in accordance with portions of the foamed heat-insulating material.

31. The production method of the foamed heat-insulating material according to claim 25, wherein the high-melting point beads each comprise an inner layer and an outer layer that differ in material, foam expansion ratio, and cell diameter, and wherein a resin of the outer layer has a higher gas barrier property than a resin of the inner layer.

32. The production method of the foamed heat-insulating material according to claim 26, wherein the high-melting point beads each comprise an inner layer and an outer layer that differ in material, foam expansion ratio, and cell diameter, and wherein a resin of the outer layer has a higher gas barrier property than a resin of the inner layer.

33. A foamed heat-insulating material wherein high-melting point beads that keep internal gas lower in thermal conductivity than air at a mold beads forming temperature and low-temperature foam beads that are foamed at the mold beads forming temperature are mixed to form the foamed heat-insulating material, and wherein the low-temperature foam beads after mold beads forming have a smaller size than the high-melting point beads.

34. The foamed heat-insulating material according to claim 33, wherein a coating layer is formed on an outer surface of each of the high-melting point beads.

35. The foamed heat-insulating material according to claim 33, wherein a ratio of the high-melting point beads and the low-temperature foam beads is changed in accordance with portions of the foamed heat-insulating material.

36. The foamed heat-insulating material according to claim 34, wherein a ratio of the high-melting point beads and the low-temperature foam beads is changed in accordance with portions of the foamed heat-insulating material.

37. The foamed heat-insulating material according to claim 33, wherein the high-melting point beads are formed of a resin material having a lower gas transmission rate than three substances, namely, polystyrene, polypropylene, and polyethylene.

38. The foamed heat-insulating material according to claim 34, wherein the high-melting point beads are formed of a resin material having a lower gas transmission rate than three substances, namely, polystyrene, polypropylene, and polyethylene.

39. The foamed heat-insulating material according to claim 33, wherein the high-melting point beads each comprise an inner layer and an outer layer that differ in material, foam expansion ratio, and cell diameter, and wherein a resin of the outer layer has a higher gas barrier property than a resin of the inner layer.

40. The foamed heat-insulating material according to claim 34, wherein the high-melting point beads each comprise an inner layer and an outer layer that differ in material, foam expansion ratio, and cell diameter, and wherein a resin of the outer layer has a higher gas barrier property than a resin of the inner layer.

41. The foamed heat-insulating material according to claim 33, wherein an outer surface of the foamed heat-insulating material is covered with a film.

42. The foamed heat-insulating material according to claim 34, wherein an outer surface of the foamed heat-insulating material is covered with a film.

43. The foamed heat-insulating material according to claim 33, wherein the high-melting point beads each comprise an inner layer and an outer layer that differ in material, foam expansion ratio, and cell diameter, and wherein a resin of the outer layer has a ratio of less than 30% to a volume of the high-melting point beads.

44. The foamed heat-insulating material according to claim 34, wherein the high-melting point beads each comprise an inner layer and an outer layer that differ in material, foam expansion ratio, and cell diameter, and wherein a resin of the outer layer has a ratio of less than 30% to a volume of the high-melting point beads.
